(19) United States
(12) Patent Application Publication
(10) Pub. No.: US 2012/0160986 A1
(43) Pub. Date: Jun. 28, 2012

(54) HOLDER FOR ATTACHING AN ASSEMBLY

(75) Inventors: Bernd Hein, Baiersbronn/Schoenmuenzach (DE); Samir Mahfoudh, Buehl (DE)

(73) Assignee: ROBERT BOSCH GMBH, Stuttgart (DE)

(21) Appl. No.: 13/393,575

(22) PCT Filed: Jul. 13, 2010
(86) PCT No.: PCT/EP10/60003

§ 371 Date: Mar. 1, 2012

(30) Foreign Application Priority Data
Sep. 1, 2009 (DE) 10 2009 029 067.2

(51) Int. Cl. F16M 13/02

(52) U.S. Cl. 248/636

(57) ABSTRACT

The invention relates to a mounting element for attaching an assembly, in particular a pump 10, to a mount 12. The mounting element 1 comprises a bracket 11 and a damping element 13. The damping element 13 comprises a first recess 131 for receiving the assembly. The damping element further comprises a contact surface 130 for contacting the bracket 11. The bracket secures the damping element 13 in the mount 12. Adjacent to the first recess 131, the damping element 13 comprises a second recess 132 which supports a radially symmetric deformation of the cross section of the first recess 131 when the bracket 11 is secured to the mount 12.

### BACKGROUND OF THE INVENTION

The invention relates to a holder for attaching an assembly, in particular for attaching a pump on a mount. The holder has a bracket and a damping element that partially comprise the assembly. The damping element has a recess that is provided for accommodating the assembly. Furthermore, the damping element has a contact surface for making contact with the bracket. The bracket is provided in order to attach the damping element on the mount.

An assembly is attached on a mount, preferably on an engine mount of a motor vehicle. In this case, the assembly is exposed to extreme conditions such as, for example, vibration loadings and temperatures that can result in damage to the assembly. A holder that is constructed from a bracket and a damping element is arranged for the purpose of attaching the assembly on the mount. The bracket is preferably made from sheet metal, and the damping element from rubber. Over its service life, the holder must fulfill the specifications and/or the conditions of use with regard to the oscillatory behavior and strength behavior. Furthermore, the natural frequency/resonant frequency of the individual components of a module differs depending on the different material dampings, stiffnesses and types of joint. In order in essence to be able to implement the required service life of the components, the natural frequency must as far as possible be avoided, or its amplitude must be damped.

### SUMMARY OF THE INVENTION

It is an object of the invention to implement a holder for an assembly with improved oscillatory behavior and strength behavior.

A holder for attaching an assembly, in particular a pump, on a mount is provided in accordance with the invention. In this case, the holder has a bracket and a damping element, the damping element comprising a first recess that is provided for accommodating the assembly. Adjacent to the first recess the damping element has a second recess that supports a radially symmetrical deformation of the cross section of the first recess when the bracket is attached on the mount.

One advantage of the inventive holder consists in that the attachment of the assembly is improved. In particular, the vibration loadings are reduced because of the damping element. Owing to the second recess, the stiffness of the damping element is at least approximately constant over the periphery of the assembly, and this leads to a better clamping joint for the assembly.

In one embodiment of the invention, the second recess is designed as a slot, the diameter of the slots decreasing in the direction of a bracket end as a function of the position of the slots. A better hold can be ensured between the damping element and the assembly with the aid of the second recess. Furthermore, it is possible to ensure a better clamping joint for the assembly on the basis of an approximately constant stiffness of the damping element.

In a further embodiment of the invention, the damping element comprises a third recess as a cutout, the cross sectional area of the cutouts increasing as a function of the position of the first recess from the middle of the bracket up to the bracket end. It is thereby possible to achieve an increase in the surface area of the damping element, and thus a better heat dissipation. Furthermore, a smaller oscillation amplitude is achieved by the low mass of the damping element.

In accordance with a further embodiment of the invention, a fourth recess is provided as a hole in the damping element, at least two holes having a different diameter. Because of the holes in the damping element, it is possible to achieve a smaller oscillation amplitude of the damping element. Furthermore, the damping element provided with holes ensures a better heat dissipation, and an increase in the surface area of the damping element.

Furthermore, in accordance with a further embodiment of the invention, in a plane of the bracket the damping element is designed in the region of the contact surface as an edge widening in a wedge shape. A constant pressure between the damping element and the assembly can be ensured by compressing the edge of the damping element. The damping element can thereby be adapted to the contours of the assembly.

### BRIEF DESCRIPTION OF THE DRAWINGS

The invention is explained in more detail below with the aid of exemplary embodiments and with reference to the attached drawings, in which:

FIG. 1 shows a holder for fitting a pump in an unmounted state of a bracket;

FIG. 2 shows the holder, shown in FIG. 1, for fitting a pump in a mounted state of the bracket;

FIG. 3 shows a sectional view of the damping element;

FIG. 4 shows a schematic of the bracket;

FIG. 5A and FIG. 5B show plan views of the bracket with a bushing or a lug; and

FIG. 6 shows a schematic of a bracket end and a contact surface.

### DETAILED DESCRIPTION

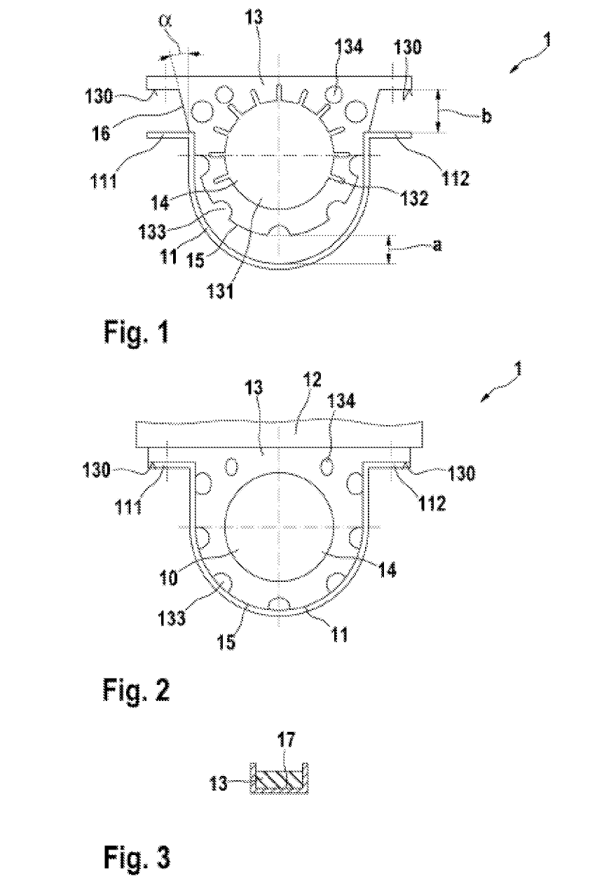

FIG. 1 shows a schematic of a holder 1 with a bracket 11 and a damping element 13 in an unmounted state. The damping element 13 comprises a contact surface 130 for making contact with the bracket 11. The bracket 11 has two bracket ends 111, 112 that, as is shown in FIG. 2, are provided for attaching the damping element 13 on the mount 12. The contact surface 130 of the damping element 13 is arranged in this case between the bracket end 111, 112 and the mount 12, and is of rectangular design. Furthermore, the damping element 13 comprises a first recess 131 that is arranged to accommodate the pump 10. The first recess 131 is arranged centrally in the damping element 13 so that the pump 10 is simultaneously damped. With the aid of the holder 1 it is possible to achieve an improved oscillatory behavior and strength behavior in conjunction with a sinusoidal and/or broadband noise excitation of 200 m/s² and a temperature of 120° C.

The damping element 13 preferably has a second recess 132 that is designed as a slot, the second recess 132 opening into the first recess 131. At least two slots are arranged in the inner region 14 of the damping element 13 with radial symmetry in relation to a midpoint of the first recess 131. The slots are provided between the bracket ends 111, 112, the diameter of the slots decreasing in the direction of a bracket end 111, 112 as a function of the position of the slots. Furthermore, the slot is of rectangular design, the narrower side of the slot opening into the first recess 131. The slot that is arranged between the bracket ends 111, 112 in the middle of the first recess 131 has the widest diameter. Starting therefrom, five slots are respectively arranged in the direction of a bracket end 111, 112. Alternatively, more or less slots can be arranged in the damping element 13. Because of the radially arranged slots, a better hold can be enabled between the damping element 13 and the pump 10. Furthermore, owing to the different diameters of the slots it is possible to achieve a stiffness of the damping element 13 in an at least approximately constant fashion over the entire periphery, and this leads to a improved clamping joint for the pump 10.

The damping element 13 comprises a third recess 133 that is designed as a cutout in an outer wall region 15 of the damping element 13. In this case, the outer wall region 15 of the damping element 13 is the region that faces the bracket 11. The third recess 133 is arranged in a plane of the bracket 11, at least two cutouts being arranged in the outer wall region 15 of the damping element 13. The cutouts are of semicircular design. The cross sectional area of the cutouts increases as a function of the position of the first recess 131 from the middle of the bracket 11 up to the bracket end 111, 112. Starting from the cutout in the middle of the bracket 11, two cutouts are respectively arranged on the sides of the outer wall region 15 up to the bracket end 111, 112. However, it is possible to provide more or fewer cutouts in the damping element 13.

In a plane of the bracket 11 a fourth recess 134 is provided in the damping element 13 as a hole in the region of the contact surface 130 in an unmounted state. However, at least two holes with a different diameter are arranged in the damping element 13. The hole that is arranged in the vicinity of the mount 12 is designed to be smaller than the hole that is arranged in the vicinity of the outer wall region 15. In the mounted state, the holes in the damping element 13 have an elliptical shape. It is possible by means of the third recess 133 and the fourth recess 134 to achieve in the damping element 13 an increase in the surface area of the damping element 13 so as to enable a better heat dissipation in the damping element 13. Furthermore, a small oscillation amplitude can be achieved owing to the low mass of the damping element 13.

In a plane of the bracket 11 the damping element 13 is designed in the region of the contact surface 130 to be wider in an unmounted state of the bracket 11 than the spacing of the bracket ends 111, 112 with a mounted bracket 11. Consequently, in the region of the contact surfaces 130 the damping element 13 is compressed by the bracket ends 111, 112 in the mounted state of the bracket 11. In a plane of the bracket 11 the damping element 13 is preferably designed in the region of the contact surface 130 as an edge 16 widening in a wedge shape in the direction of the bracket ends 111, 112 in the direction of the contact surface 130. The angle a of the edge 16 is, however, dependent on size so that, given a larger pump 10, the angle a of the edge 16 is also designed to be larger. The spacing a that is provided between the bracket 11 and the outer wall region 15 of the damping element 13 is of smaller design than the spacing b that is provided between the bracket ends 111, 112 and the contact surface 130. This gives rise to a difference in size that can be used to implement an axial clamping. As shown in FIG. 2, a uniform pressure can be implemented along the periphery of the damping element 13 with the aid of the axial and radial clamping of the damping element 13 with the bracket 11. If the damping element 13 is clamped only axially with the bracket 11, a partial pressure results between the damping element 13 and the pump 10 so that the damping element 13 is deformed in an oval fashion. The pump 10 can thereby become detached from the holder 1 because of the vibration loading.

The damping element 13 is preferably constructed from an elastomer. Alternatively, however, it is also possible to use another material that is suitable for damping a pump 10. Furthermore, the outer wall region 15 of the damping element 13 is designed as a channel 17 as is shown in FIG. 3. The bracket 11 is thereby fixed by the damping element 13 so as to enable a better hold of the bracket 11, and the damping element 13 is prevented from slipping out during operation.

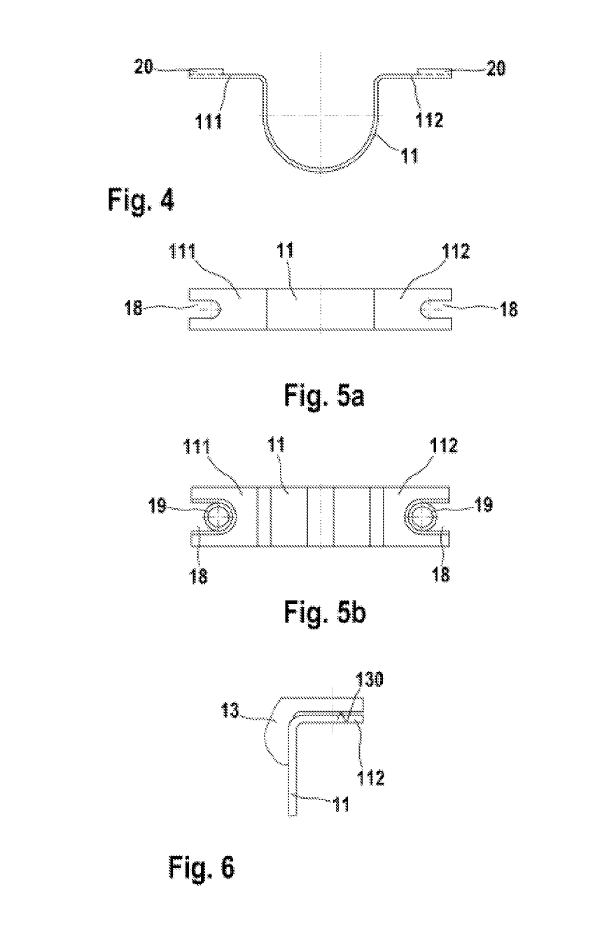

Large axial forces caused by the threaded joint can be produced during the attaching of the damping element 13 between the bracket 11 and the mount 12. In consort with the angular geometry of the bracket 11, this distortion of the damping element 13 can lead to damage to the damping element 13. As is shown in FIGS. 4 and 5A, a lug 20 is embossed in a gap 17 in the bracket end 111, 112 in order to avoid this. As shown in FIG. 5B, instead of the lug 20 it is also possible to provide a bushing 19 in the gap 17 in the bracket ends 111, 112. The bushing 19 and the lug 20, which are inwardly deformed ensure that the necessary clamping torque of the threaded joint of the bracket 11 and the mount 12 does not result in damage to the damping element 13. As is shown in FIG. 6, the bracket 11 is thereby completely decoupled from the mount 12 so that the distorted length can be limited and it is thereby possible to prevent damage owing to excessively high stressing of the damping element 13. The bracket 11 is preferably made from metal. However, it is also possible to use another material for the bracket 11.

The invention is illustrated using the example of a pump 10. However, the invention can also be used for other assemblies that are attached on a mount 12. What is decisive here is the fact that adjacent to the first recess 131 the damping element 13 has the second recess 132, which supports a radially symmetrical deformation of the cross section of the first recess 131 during attachment of the bracket 11 to the mount 12. The desired service life of the pump 10 can thereby be implemented with the aid of the damping element 13. Furthermore, the damping element 13 can be adapted to the contours of the pump 10 owing to the second, third and fourth recesses 132, 133, 134.

1. A holder for attaching an assembly, on a mount (12), the holder (1) having a bracket (11) and a damping element (13), the damping element (13) having a first recess (131) that is provided for accommodating the assembly, the damping element (13) having a contact surface (130) for making contact with the bracket (11), the bracket (11) being provided for attaching the damping element (13) on the mount (12), characterized in that adjacent to the first recess (131) the damping element (13) has a second recess (132) that supports a radially symmetrical deformation of the cross section of the first recess (131) when the bracket (11) is attached on the mount (12).

2. The holder as claimed in claim 1, characterized in that the second recess (132) is a slot that opens into the first recess (131).

3. The holder as claimed in claim 2, characterized in that the slot is arranged in an inner region (14) of the damping element (13) with radial symmetry in relation to a midpoint of the first recess (131).

4. The holder as claimed in claim 2, characterized in that at least two slots are arranged with radial symmetry in the inner region (14) of the damping element (13), the bracket (11) having two ends (111, 112) that are provided for attachment on the mount (12), the slots being provided between the bracket ends (111, 112), the diameter of the slots decreasing in the direction of a bracket end (111, 112) as a function of the position of the slots.

5. The holder as claimed in claim 1, characterized in that the damping element (13) comprises a third recess (133), the third recess (133) being in an outer wall region (15) of the damping element (13) as a cutout that faces the bracket (11).

6. The holder as claimed in claim 5, characterized in that the third recess (133) is arranged in a plane of the bracket (11), at least two cutouts being arranged in the outer wall region (15) of the damping element (13), the cross sectional area of the cutouts increasing as a function of the position of the first recess (131) from the middle of the bracket (11) up to the bracket end (111, 112).

7. The holder as claimed in claim 1, characterized in that in a plane of the bracket (11) a fourth recess (134) is provided as a hole in the damping element (13) in the region of the contact surface (130) in an unmounted state.

8. The holder as claimed in claim 7, characterized in that the fourth recess (134) has at least two holes with a different diameter in the damping element (13).

9. The holder as claimed in claim 1, characterized in that in a plane of the bracket (11) the damping element (13) is designed in the region of the contact surface (130) to be wider in an unmounted state of the bracket (11) than the spacing of the bracket ends (111, 112) with a mounted bracket (11) so that in the region of the contact surface (130) the damping element (13) is compressed by the bracket ends (111, 112) in the mounted state of the bracket (11).

10. The holder as claimed in claim 9, characterized in that in a plane of the bracket (11) the damping element (13) is designed in the region of the contact surface (130) as an edge (16) widening in a wedge shape in the direction of the bracket ends (111, 112) in the direction of the contact surface (130).

11. The holder as claimed in claim 2, characterized in that the slot is arranged in an inner region (14) of the damping element (13) with radial symmetry in relation to a midpoint of the first recess (131).

12. The holder as claimed in claim 11 , characterized in that at least two slots are arranged with radial symmetry in the inner region (14) of the damping element (13), the bracket (11) having two ends (111, 112) that are provided for attachment on the mount (12), the slots being provided between the bracket ends (111, 112), the diameter of the slots decreasing in the direction of a bracket end (111, 112) as a function of the position of the slots.

13. The holder as claimed in claim 12, characterized in that the damping element (13) comprises a third recess (133), the third recess (133) being in an outer wall region (15) of the damping element (13) as a cutout that faces the bracket (11).

14. The holder as claimed in claim 13, characterized in that the third recess (133) is arranged in a plane of the bracket (11), at least two cutouts being arranged in the outer wall region (15) of the damping element (13), the cross sectional area of the cutouts increasing as a function of the position of the first recess (131) from the middle of the bracket (11) up to the bracket end (111, 112).

15. The holder as claimed in claim 14, characterized in that in a plane of the bracket (11) a fourth recess (134) is provided as a hole in the damping element (13) in the region of the contact surface (130) in an unmounted state.

16. The holder as claimed in claim 15, characterized in that the fourth recess (134) has at least two holes with a different diameter in the damping element (13).

17. The holder as claimed in claim 16, characterized in that in a plane of the bracket (11) the damping element (13) is designed in the region of the contact surface (130) to be wider in an unmounted state of the bracket (11) than the spacing of the bracket ends (111, 112) with a mounted bracket (11) so that in the region of the contact surface (130) the damping element (13) is compressed by the bracket ends (111, 112) in the mounted state of the bracket (11).

18. The holder as claimed in claim 17, characterized in that in a plane of the bracket (11) the damping element (13) is designed in the region of the contact surface (130) as an edge (16) widening in a wedge shape in the direction of the bracket ends (111, 112) in the direction of the contact surface (130).
